(19) United States
(12) Patent Application Publication
(10) Pub. No.: US 2010/0169830 A1
(43) Pub. Date: Jul. 1, 2010

(54) Apparatus and Method for Selecting a Command

(75) Inventors: Christian Kraft, Frederiksberg (DK); Peter Dam Nielsen, Lyngby (DK)

Correspondence Address: Perman & Green, LLP, 99 Hawley Lane, Stratford, CT, 06614, US

(73) Assignee: NOKIA CORPORATION, Espoo (FI)

(21) Appl. No.: 12/597,248

(22) PCT Filed: Jun. 20, 2007
(86) PCT No.: PCT/IB07/01845

§ 371 Date: Mar. 18, 2010

Related U.S. Application Data
(60) Provisional application No. 60/914,074, filed on Apr. 26, 2007.

(51) Int. Cl. G06F 3/048

(52) U.S. Cl. 715/810

(57) ABSTRACT

A method for selecting a command in a mobile communication terminal that includes a display and a character input device is disclosed. The method includes detecting input of at least one character using the character input device; displaying a list of commands associated with the at least one character; and detecting a selection input associated with a command of the list. A corresponding mobile communication terminal, apparatus, and computer program product are also presented.

### CROSS REFERENCE TO RELATED APPLICATIONS

This application is the National Stage of International Application No. PCT/IB2007/001845 International Filing Date, 20 Jun. 2007, which designated the United States of America, and which International Application was published under PCT Article 21 (2) as WO Publication No. 2008/132534 A1 and which claims priority from and the benefit of U.S. application Ser. No. 60/914,074 filed on 26 Apr. 2007, the disclosures of which are incorporated herein by reference in their entireties.

### BACKGROUND

1. Field

The disclosed subject matter relate to a selection method, a mobile communication terminal, an apparatus and a computer program product comprising instructions for carrying out said method.

2. Brief Description of Related Developments

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc. The amount of options and functions available in certain mobile terminal applications is increasing for every phone generation.

Carrying out an action or finding a command in an application is becoming increasingly cumbersome and often involves scrolling through long option lists. Consequently, to be able to provide a user-friendly way to select among all the available options, there is an increasing need to provide simple, flexible, and intuitive selection methods.

### SUMMARY

According to a first aspect there is provided a method for selecting a command in a mobile communication terminal comprising a display and a character input device, the method comprising:

detecting input of at least one character using the character input device;
displaying a list of commands associated with the at least one character; and
detecting a selection input associated with a command of the list.

A user of an apparatus according to one embodiment may thus find available options or commands from within an application simply by using character input, instead of using complex menus.

The list of commands may be associated with a current context of the mobile communication terminal. In other words, the displayed commands are all relevant to the currently running application or applications.

The method may comprise:

executing software processing instructions associated with the selection input.

The at least one character may comprise more than one character and the displaying a list of commands associated with the at least one character may be updated after input of each one of the at least one character. The list is then dynamically updated after each character input, allowing better feedback to the user and thus improved usability.

In the displaying a list of commands, the beginning of at least one word of a label of each command in the list of commands may correspond to the at least one character. This is intuitive for the user and often corresponds to how the user thinks. The word does not need to be the first word of the command.

In the displaying a list of commands, the list of commands may include at least one command being associated with at least one alternative word describing the at least one command, and the beginning of one of the at least one alternative word may correspond to the at least one character. In other words, synonyms can be stored to allow a user to invoke a command even if the user can not think of the exact terminology used in the mobile communication terminal in question.

In the detecting input, the character input device may utilise predictive text entry functionality. The possible words can then be limited to the possible commands that can be invoked in the current context.

The method may be invoked by an actuation of an actuator, the actuation being longer that a threshold time period.

According to a second aspect there is provided a mobile communication terminal comprising a controller, a display and a character input device,

the controller being configured to detect input of at least one character via the at least one character input device;
the controller being configured to, as a response to the input, display a list of commands associated with the at least one character; and
the controller being configured to detect a selection input associated with a command of the list.

The display may further comprise a first display section showing the at least one character and a second display section showing the list of commands associated with the at least one character.

The character input device may further be an input device selected from the group comprising: a numeric keypad, an alphanumeric keypad, a scroll wheel, a pressable scrollwheel, a multidirectional joystick, a track ball, a disc dial, a touch sensitive screen, and any combination of the above.

The mobile communication terminal may further comprise:

a controller;
a character input device being adapted to detect input of at least one character;
a display being adapted to display a list of commands associated with the at least one character; and
means for detecting a selection input associated with a command of the list.

According to a third aspect there is provided an apparatus comprising a controller, a display and a character input device,

the controller being configured to detect input of at least one character via the at least one character input device;
the controller being configured to display a list of commands associated with the at least one character; and
the controller being configured to detect a selection input associated with a command of the list.

According to a fourth aspect there is provided a computer program product comprising instructions for:

detecting input of at least one character using a character input device;

displaying a list of commands associated with the at least one character; and

detecting a selection input associated with a command of the list.

The computer program product may further comprise instructions for:

executing software processing instructions associated with the selection input.

According to a fifth aspect there is provided a user interface for a mobile communication terminal comprising:

a character input device being adapted to detect input of at least one character;
a display being adapted to display a list of commands associated with the at least one character; and
a selection input detector for detecting a selection input associated with a command of the list.

Other aspects, features and advantages of the disclosed embodiments will appear from the following detailed disclosure, from the attached claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

The above, as well as additional aspects, features and advantages of the disclosed embodiments, will best be understood through the following illustrative and non-limiting detailed description of the preferred embodiments, with reference to the appended drawings, wherein:

### BRIEF DESCRIPTION OF THE DRAWINGS

FIG. 1 is a schematic illustration of a cellular telecommunication system, as an example of an environment in which the subject matter of this application may be applied.

FIG. 2 is a schematic view illustrating a mobile terminal according to an embodiment.

FIG. 3 is a schematic block diagram representing an internal component, software and protocol structure of the mobile terminal shown in FIG. 2.

FIG. 4 is a flowchart diagram of a method according to an embodiment.

FIG. 5 is a schematic illustration of a display view of an embodiment.

FIG. 6 is a schematic illustration of a display view of an embodiment.

FIG. 7 is a schematic illustration of a display view of an embodiment.

### DETAILED DESCRIPTION OF THE DISCLOSED EMBODIMENTS

The disclosed embodiments now will be described more fully hereinafter with reference to the accompanying drawings, in which certain aspects of the disclosed embodiments are shown. The disclosed embodiments may, however, be embodied in many different forms and should not be construed as limited to the embodiments set forth herein; rather, these embodiments are provided by way of example so that this disclosure will be thorough and complete, and will fully convey the scope of the disclosed embodiments to those skilled in the art. Like numbers refer to like elements throughout.

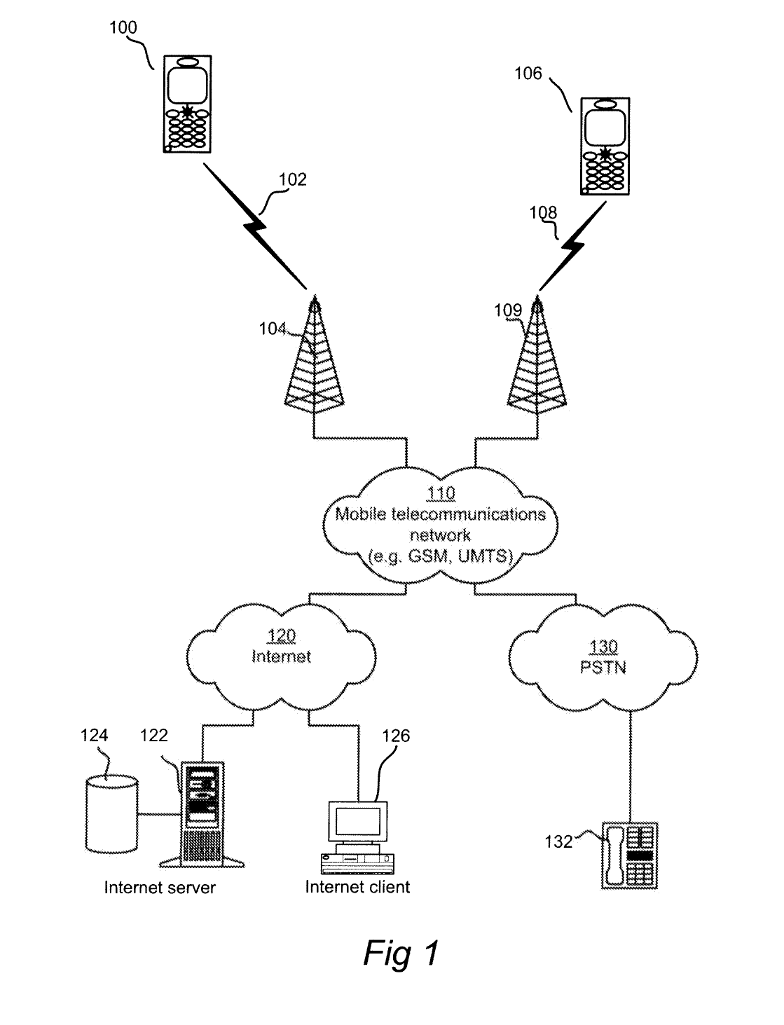

FIG. 1 illustrates an example of a cellular telecommunications system in which aspects of the disclosed embodiments may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to an embodiment and other devices, such as another mobile terminal 106 or a stationary telephone 132. It is to be noted that for different embodiments of the mobile terminal 100 and in different situations, different ones of the telecommunications services referred to above may or may not be available.

The mobile terminals 100, 106 are connected to a mobile telecommunications network 110 through RF links 102, 108 via base stations 104, 109. The mobile telecommunications network 110 may be in compliance with any commercially available mobile telecommunications standard and/or protocol suite, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

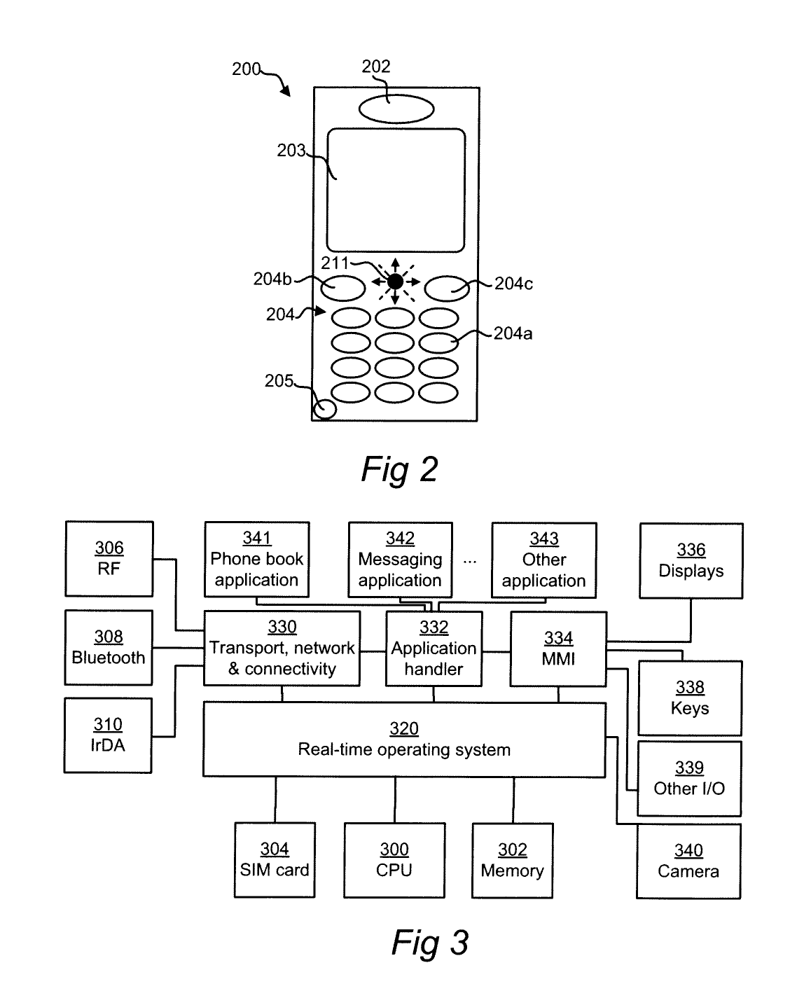

An embodiment 200 of the mobile terminal 100 is illustrated in more detail in FIG. 2. The mobile terminal 200 comprises a display 203 for providing output from the mobile terminal 200 to a user. The mobile terminal 200 further comprises a speaker or earphone 202, a microphone 205 and a set of internal keys 204 which may include a keypad 204a of common ITU-T type (alpha-numerical keypad representing characters “0”-“9”, “*” and “#”) and certain other keys such as soft keys 204b, 204c, and a joystick 211 or other type of navigational input device.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications include a phone book application 341, a messaging application 342 for sending and receiving messages such as SMS, MMS, emails, etc., as well as various other applications 343, such as applications for voice calling, video calling, an instant messaging application, a phone book application, a calendar application, a word processing application, a presentation application, a spreadsheet application, a control panel application, a camera application, one or more video games, etc.

The MMI 334 also includes one or more hardware controllers, which together with the MMI drivers cooperate with the displays 336 (internal and external where applicable), keys 338 (internal and external where applicable) as well as various other I/O devices 339 such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a person skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

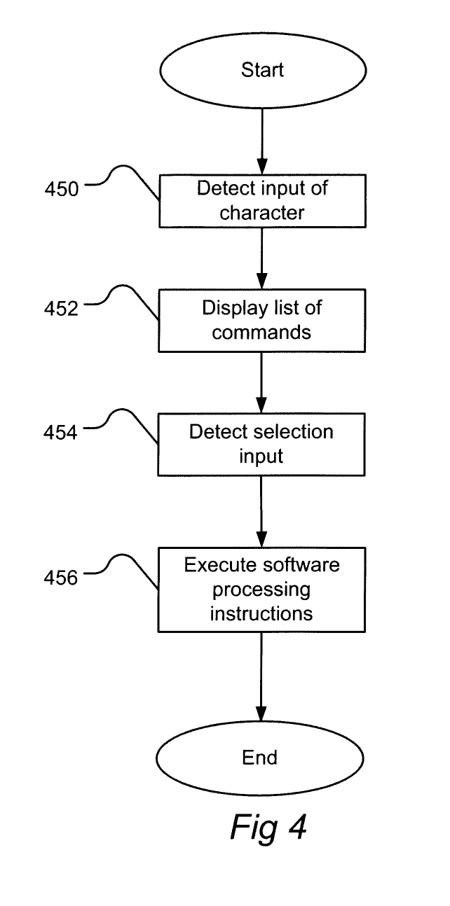

FIG. 4 is a flowchart diagram illustrating the execution of the mobile terminal 200 shown in FIG. 2 for selection of an option in a current context of the mobile terminal 200 by using character entry.

In an initial detect input of character step 450, the mobile terminal detects the input of at least one character inputted by the user. A user enters characters using a character input device, which for example can be a keypad using multi-tap text entry or predictive text entry, e.g. T9. Multi-tapping works by the user pressing a number of times on a numeric key to input a desired character, e.g. by pressing the key representing “8/tuv” three times to input the character “v”. Entry via a touch screen using character recognition or an on-screen keyboard is also possible, as is any other text entry method, e.g. using a scroll wheel, a pressable scrollwheel, a multidirectional joystick, a track ball, a disc dial or any combination of the above.

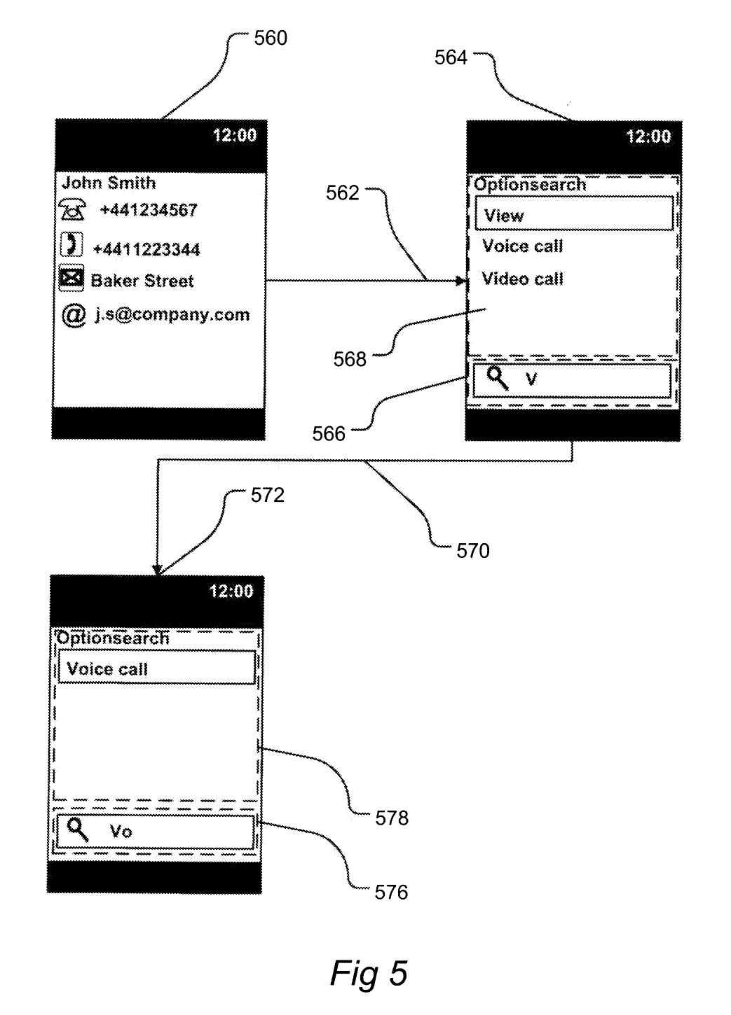

In a display list of commands step 452, the mobile terminal displays, based on the detected characters in the previous step 450, a list of commands associated with the detected characters. The list is filtered using the detected characters, as is explained in more detail in conjunction with FIGS. 5-7 below. The list is updated after each entry, typically resulting in a shorter list as the filter of the detected characters is more specific.

In a detect selection input step 454, the mobile terminal detects an option selected by the user. The user can make this selection by using a soft key, a “Yes”-key, a dedicated button for this purpose, or a voice command.

In an execute software processing instructions step 456, the mobile terminal executes instructions corresponding to the selected option.

It is to be noted that this method may be invoked in several ways. For example, the mobile terminal can be pre-configured for which applications and for which contexts the method shall be possible to be invoked. There could also be a possibility for the user of the mobile terminal to configure for which applications and for which contexts the method shall be possible to be invoked. A special case here is an application using text entry, e.g. the messaging application, where the method naturally could not be invoked as the keys already are used for typing. There might be other applications where the keys already have other functions, but for these situations the user could be offered a user setting defining how to invoke the method. Another possibility is to enable the method to be invoked by a long-press of a certain key or one of a group of keys, i.e. a key stroke lasting longer than a threshold time period, thus enabling more applications to use the method.

Below follows a description of a few user interface scenarios according to aspects of the disclosed embodiments. The method of searching and selecting an option will be explained by a series of examples. However, as will be readily understood by a person skilled in the art, the principle applies in a similar way to other contexts, such as changing phone settings, media applications, service applications, etc.

FIG. 5 illustrates an example of a user interface scenario according to one embodiment. A first display view 560 displayed on the display 203 of the mobile terminal 200 is shown. The first display view 560 shows an entry in the phone book application comprising general information about a person's phone numbers, address, and e-mail, etc. The user starts typing the first word in the desired option, e.g. “Voice call”, by first entering the character “V” using the character input device as described above. As a result of this input 562 the user is presented with a second display view 564. The second display view 564 comprises a first display section 566 showing the entered character, in this case “V”, and a second display section 568, showing a list of options associated with the entered character, in this case all options commencing with the character “V”. The user can then either scroll through the list of options and select the desired option or continue typing the first word, e.g. “Voice”, in a desired option, “Voice call”, by entering the character “o”. As a result of this input 570 the user is presented with a third display view 572. The third display view 572 comprises a first display section 576, showing the two entered characters, in this case “Vo”, and a second display section 578, showing a list of options associated with the two entered characters, in this case all options commencing with the letters “Vo”. It is to be noted that entry of the second character is not necessary; the user can, if desired in the second view 564, first scroll through the list of options and then select the presented option if it is the desired one.

In other words, the user filters the number of available options in the list by entering one or more characters, until the list is sufficiently small for the user to select the desired option, optionally by using the navigational input device 211 to select an option, which is not first in the list. It should be noted that the user can at any time decide to exit the search for options or erase the entered characters and start a new search.

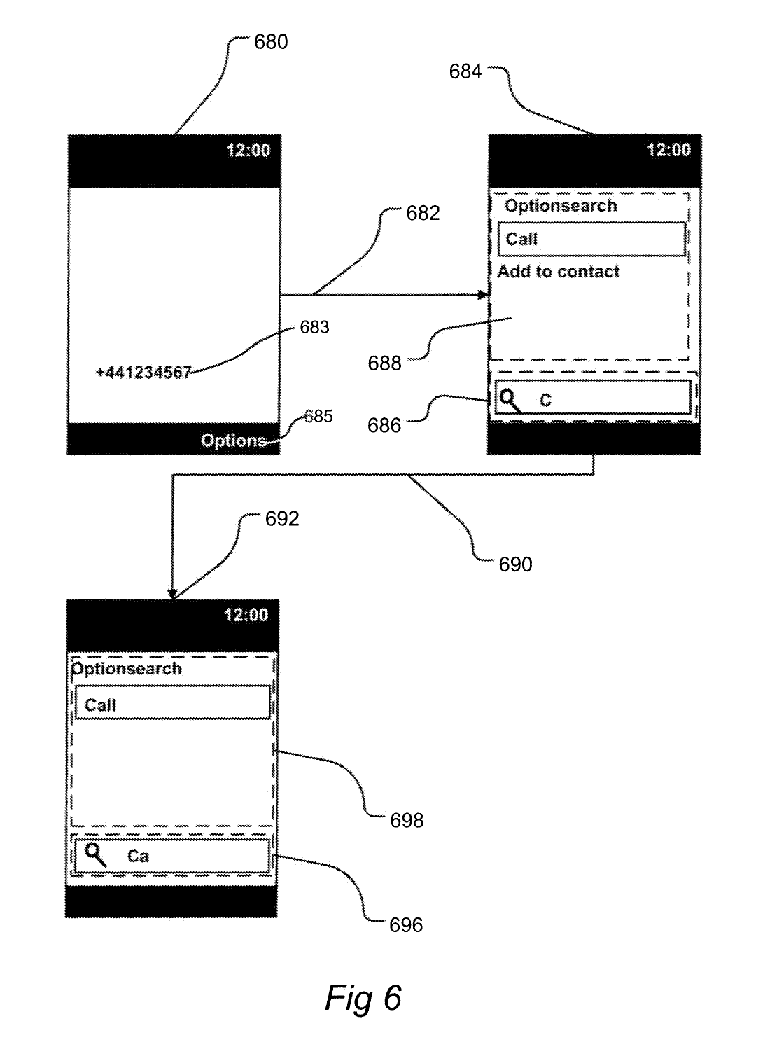

FIG. 6 illustrates another example of a user interface scenario according to an embodiment. A first display view 680 displayed on the display 203 of the mobile terminal 200 is shown. The first display view 680 shows an entry of a phone number 683. The user invokes 682 the method for command selection e.g. by actuating the right soft key 204c associated with “options” 685. As a result of this input 682, the user is presented with a second display view 684. The user then starts typing a word, in this example “call” in a desired option, “Call”, by first entering the character “C”. The entered character, in this case “C”, is then displayed in a first display section 686, and a second display section 688, shows a list of options associated with the entered character, in this example all options containing a word commencing with the letter “C”. The user can then either scroll through the list of options and select the desired option or continue typing the word “Call” by entering the character “a”. As a result of this input 690 the user is presented with a third display view 692. The third display view 692 comprises a first display section 696 showing the two entered characters, in this case “Ca”, and a second display section 698 showing a list of options associated with the two entered characters, in this case all options commencing with the letters “Ca”. It should be noted that the user can at any time decide to exit the search for options or erase the entered characters and start a new search.

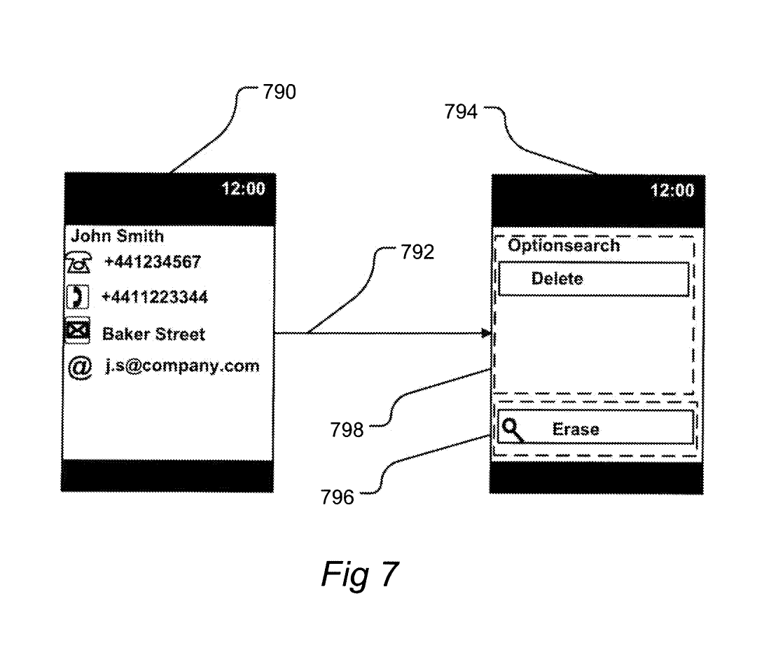

FIG. 7 illustrates yet another example of a user interface scenario according to an embodiment. A first display view 790 displayed on the display 203 of the mobile terminal 200 is shown. The first display view 790 shows an entry in the phone book application comprising general information about a person's phone numbers, address, and e-mail address, etc. If the user for example desires to perform the option “Delete” but cannot think of the correct word, he or she might start typing for example an alternative and equivalent word “Erase” instead. As a result of this input 792 the user is presented with a second display view 794. The display view 794 comprises a first display section 796 showing the entered characters, in this case the word “Erase” or, which would also be possible, parts of this word, and a second display section 798 showing a list of options associated with the entered characters, in this case the option “Delete”. In this embodiment, at least part of possible options thus have at least one alternative word associated with them. This association can for example be stored in the memory 302 of FIG. 3. The user can then either scroll through the list of options and select the desired option or continue typing the alternative word in the desired option. It should be noted that the user can at any time decide to exit the search for options or erase the entered characters and start a new search.

A particular advantage of the presented embodiments relates to the user being able to use his own language when looking for options from within an application. In one embodiment, this is achieved by offering alternative words for each option, thus creating an intelligent search function. For example, the user is able to find the option “Delete” even if he or she types “Erase” instead.

The subject matter of the present application has mainly been described above with reference to a few embodiments. However, as is readily appreciated by a person skilled in the art, other embodiments than those disclosed above are equally possible within the scope of the present application, as defined by the appended patent claims.

What is claimed is:

1. A method for selecting a command in a mobile communication terminal comprising a display and a character input device, said method comprising:
detecting input of at least one character using said character input device;
displaying a list of commands associated with said at least one character; and
detecting a selection input associated with a command of said list.

2. The method according to claim 1, wherein said list of commands is further associated with a current context of said mobile communication terminal.

3. The method according to claim 1, further comprising:
executing software processing instructions associated with said selection input.

4. The method according to claim 1, wherein when said at least one character comprises more than one character, said displaying a list of commands associated with said at least one character is updated after input of each one of said at least one character.

5. The method according to claim 1, wherein in said displaying a list of commands, the beginning of at least one word of a label of each command in said list of commands corresponds to said at least one character.

6. The method according to claim 1, wherein in said displaying a list of commands, said list of commands includes at least one command being associated with at least one alternative word describing said at least one command, and the beginning of one of said at least one alternative word corresponds to said at least one character.

7. The method according to claim 1, wherein in said detecting input, said character input device utilises predictive text entry functionality.

8. The method according to claim 1, wherein said method is invoked by an actuation of an actuator, said actuation being longer that a threshold time period.

9. A mobile communication terminal comprising a controller, a display and a character input device,
said controller being configured to detect input of at least one character via said at least one character input device;
said controller being configured to, as a response to said input, display a list of commands associated with said at least one character; and
said controller being configured to detect a selection input associated with a command of said list.

10. The mobile communication terminal according to claim 9, wherein said display comprises a first display section showing said at least one character and a second display section showing said list of commands associated with said at least one character.

11. The mobile communication terminal according to claim 9, wherein said character input device is an input device selected from the group comprising: a numeric keypad, an alphanumeric keypad, a scroll wheel, a pressable scrollwheel, a multidirectional joystick, a track ball, a disc dial, a touch sensitive screen, and any combination of the above.

12. A mobile communication terminal comprising:
a controller;
a character input device being adapted to detect input of at least one character;
a display being adapted to display a list of commands associated with said at least one character; and
means for detecting a selection input associated with a command of said list.

13. An apparatus comprising a controller, a display and a character input device,
said controller being configured to detect input of at least one character via said at least one character input device;
said controller being configured to display a list of commands associated with said at least one character; and
said controller being configured to detect a selection input associated with a command of said list.

14. A computer program product comprising instructions for:
detecting input of at least one character using a character input device;
displaying a list of commands associated with said at least one character; and
detecting a selection input associated with a command of said list.

15. The computer program product according to claim 14, further comprising instructions for:
executing software processing instructions associated with said selection input.

16. A user interface for a mobile communication terminal comprising:
a character input device being adapted to detect input of at least one character;
a display being adapted to display a list of commands associated with said at least one character; and
a seletion input detector for detecting a selection input associated with a command of said list.
